(19) United States
(12) Patent Application Publication
(10) Pub. No.: US 2025/0202132 A1
(43) Pub. Date: Jun. 19, 2025

(54) SMART ANTENNA FOR POSITIONING OF OBJECTS USING BLUETOOTH TECHNOLOGY

(71) Applicant: SPARKPARK AS, Oslo (NO)

(72) Inventor: Irene Anite JENSEN, Trondheim (NO)

(21) Appl. No.: 18/849,337

(22) PCT Filed: Feb. 21, 2023
(86) PCT No.: PCT/NO2023/050041

§ 371 Date: Sep. 20, 2024

(30) Foreign Application Priority Data
Mar. 23, 2022 (NO) 20220352

(51) Int. Cl. H01Q 21/06; H01Q 3/24; H01Q 3/36

(52) U.S. Cl. CPC H01Q 21/065; H01Q 3/24; H01Q 3/36

(57) ABSTRACT

The present invention provides a real-time location tracking antenna configured to locate tags, the real-time location tracking antenna is a single locator switched lobe antenna for 2D positioning which at least comprises: at least three patch antenna elements in an antenna, means configured to set up at least three overlapping lobes in desired 2D FOV where the means is one of: i. one first controller including one phase shifter module ii. one second controller including one switching device. It is also disclosed a real-time location tracking antenna system for 3D positioning.

### TECHNICAL FIELD

The present invention relates to a real-time location tracking antenna and a system including one or more real-time location tracking antennas.

### BACKGROUND ART

Within the transport sector, the logistics sector and elsewhere in society, object tracking has become increasingly widespread. GNSS in combination with wireless communication devices has been the driving force for this development.

The e-scooter has made its entrance in many cities and the lessor of e-scooters has a desire to continuously track the position of e-scooters. The retail trade has changed significantly in recent years and there are continuously huge quantities of packages on the way from suppliers to end users, shipping agents, sender and recipient have a desire for packages to be tracked in real-time.

Traceability requires that the objects to be tracked can be “read”, traditionally one has used barcodes and QR codes for this, but this requires visual visibility, and the reading distance can be measured in cm. Longer reading range which do not require the tags to be visual to the reader is obtained with RFID (radio frequency identification). RFID is typically associated with passive tags (transponder), which do not require batteries. For even longer reading ranges the tag requires a battery and is known as active RFID. Bluetooth (BLE) can be an active tag. It is becoming more and more common with traceability via GPS and for example Bluetooth. The object to be tracked can then be in communication with fixed Bluetooth receivers/transmitters that communicate continuously with objects to be tracked, the permanently installed Bluetooth transmitters/receivers can for example be in communication with the internet via WLAN or mobile phone technology can be used for communication with a central unit.

A disadvantage of GPS is the lack of accuracy with small receiver antennas integrated in small tags, it is the case that if you want to have control over the placement of goods in a warehouse with a few centimetres' accuracy, you cannot rely on GPS, also GPS requires free sight to the sky and the satellites to operate. GPS will not function for indoor positioning like in a warehouse.

Location and tracking antennas are known from patent publications for example US2019180588 A1 discloses a method for locating a radio frequency identification (RFID) tag, comprising: monitoring by an RFID reader device at least two distance measurements of an RFID tag from the RFID reader device; monitoring a relative location of the RFID reader device for each of the distance measurements by analyzing orientation data and translational movement data of the RFID reader device; and calculating a location of the RFID tag relative to a current location of the RFID reader device based on the at least two distance measurements and the relative locations.

US2020037109 A1 discloses devices, systems, and methods for device location tracking with antenna switching comprising the steps of: receiving signal from BLE device; estimating phase vector; storing phase vector; converting phase vector; performing singular value decomposition (SVD); processing column of matrix from SVD; finding angle of arrival; determining location; selecting antenna states; configuring location of device.

WO2017127743 A1 discloses a system for asset tagging, including, at least one leaf data communication node adapted to be attached to a physical asset, wherein the leaf data communication node is configured to continuously communicate in real time using the Bluetooth Low Energy protocol with at least one receiver node that collects real time information about the location of a plurality of assets.

US2019081514 A1 discloses an intelligent wireless power transmitter comprising an array antenna module, synchronizer, phase shifter, amplifier and local controller.

There is therefore a need for more accurate object tracking systems.

### DISCLOSURE OF INVENTION

An object of the invention is to provide a real-time location tracking antenna without the disadvantages of the real time location tracking antennas of the prior art by providing a real-time location tacking antenna configured to locate tags, the real-time location tracking antenna is a single locator switched lobe antenna for 2D positioning which at least comprises:
a. at least three patch antenna elements in an antenna;
b. means configured to set up at least three overlapping lobes in desired 2D FOV where each lobe overlaps with a neighbouring lobe, where the means is one of:
   i. one first controller including one phase shifter module where the overlapping lobes are obtained by controlling the phase to each of the patch antenna elements utilising the phase shifter where the first controller at least comprises:
      recording means configured to:
      read RSSI values from each of the at least three overlapping antenna lobes, and
      the first controller is configured to record the read RSSI values, and monopulse values in elevation and azimuth is calculated by the first controller based on RSSI values from overlapping lobes, thereby providing real-time 2D location tracking, and
   ii. one second controller including one switching device and where the switching device is configured to switch between the at least three patch antenna elements, where the second controller at least comprises:
      recording means configured to:
      read RSSI values from each of the at least three patch antenna elements, and
      the second controller is configured to record the read RSSI values, and monopulse values in elevation and azimuth is calculated by the second controller based on RSSI values from overlapping lobes, thereby providing real-time 2D location tracking.

The recoding means may at least comprise:
i. a microprocessor;
ii. memory modules, and
iii. at least three switches for connection between the microprocessor and each of the patch antenna elements.

The one phase shifter module may include at least three phase shifters where each of the at least three phase shifters are in functional communication with one patch antenna element.

The real time tracking antenna may comprise at least three equidistant arranged patch antenna elements on a single planar PCB. The PCB may include from the top: a top overlay, a top solder surface material, a copper top layer, a dielectric, copper bottom layer, a bottom solder surface and a bottom overlay, the PCB further includes five coax connectors for connection with the phase shifter module.

The one switching device may include at least three output ports, where each of the at least three output ports are connected with a patch antenna element.

The real time tracking antenna may either comprise at least three 1-patch antenna PCBs arranged tilted relative to an XY-plane, or where the real time tracking antenna comprises at least three 1-patch antenna PCBs arranged tilted relative to an XY-plane and another patch antenna PCB arranged substantially parallel to an XY-plane. The patch antenna PCB may be arranged substantially parallel to an XY-plane provides a boresight lobe and/or an RFID enabler.

The tilting angle of the three tilted 1-patch antenna PCBs may be adjustable thereby enabling to tune field of view and lobe overlap between 1-patch antenna elements, where each of the PCBs may include from the top: a top overlay, a top solder surface material, a copper top layer, a dielectric, copper bottom layer, a bottom solder surface and a bottom overlay, each of the PCBs further includes one coax connector for connection with the switching module.

In one aspect the tilted 1-patch antenna PCBs may be tilted with the same absolute angle and each of the tilted 1-patch antenna PCBs are arranged in a right square frustum fashion, each of the tilted 1-patch antenna PCBs base being oriented parallel with separate side surfaces in the right square frustum fashion.

In another aspect the tilted 1-patch antenna PCBs are tilted with the same absolute angle and each of the tilted 1-patch antenna PCBs are arranged in a triangular frustum fashion, each of the tilted 1-patch antenna PCBs base being oriented parallel with separate side surfaces in the triangular frustum fashion.

For the square frustum fashion and the triangular frustum design the overlapping lobe pattern may be provided due to the relative geometric orientation between each of the tilted 1-patch antenna PCB boards.

The 1-patch antenna PCBs may be provided with a circular protruding edge along the perimeter of the circular PCB, where the circular protruding edge is electrically connected to a ground plane of the 1-patch antenna PCB. The protruding edge is configured to work as a waveguide, and it may also be described as a fence/sleeve which protrudes from the perimeter of the circular PCB.

The fifth 1-patch antenna PCB may be arranged in a right square frustum fashion on a top surface of the right square frustum described above.

In one embodiment it is also provided a real-time location tracking antenna system for 3D positioning which at least comprises two real-time location tracking antennas where the two real time location tracking antennas are spatially separated and where a controller system reads 2D positioning values from the at least two real time location tracking antennas thereby providing a 3D positioning system. The 2D real-time location tracking antennas can be of the types described above.

### BRIEF DESCRIPTION OF DRAWINGS

The invention will now be described in greater detail in the form of exemplary embodiments with reference to the drawings, in which

FIG. 1 shows a board with 5 patch antennas—5-patch PCB

FIG. 2 shows a board with 5 patch antennas—5-patch PCB

FIG. 3a shows a top layer of a PCB with 5 patch antennas—5-patch PCB,

FIG. 3b shows a ground layer of a PCB with 5 patch antennas—5-patch PCB,

FIG. 4 shows an example of the layers of a PCB according to one embodiment of the present invention,

FIG. 5 shows a board with 1 patch antenna—1-patch PCB—with a surrounding edge standing vertically up from the perimeter of the PCB,

FIG. 6 shows a board with 1 patch antenna—1-patch PCB—with a surrounding edge standing vertically up from the perimeter of the PCB,

FIG. 7a shows four 1-patch PCBs, (the fifth 1-patch is hidden behind 1-patch PCB 72,

FIG. 7b shows five 1-patch PCB's,

FIG. 8 shows four 1-patch PCBs, and

FIG. 9 shows a phase shifter/control board.

### MODE(S) FOR CARRYING OUT THE INVENTION

In the following, general embodiments as well as particular exemplary embodiments of the invention will be described. References will be made to the accompanying drawings. It shall be noted, however, that the drawings are exemplary embodiments only, and that other features and embodiments may well be within the scope of the invention as claimed.

Unless otherwise defined, all terms of art, notations and other scientific terms or terminology used herein are intended to have the meanings commonly understood by those of skill in the art to which this invention pertains.

One object of the present invention is to provide accurate and real-time location tracking of tags. The real-time location tracking antennas of the present invention combines several types of position determination, such as AoA, RSSI values and to extract the angular position from a monopulse principle on the RSSI amplitude. In addition, anchor tags may be used to increase position accuracy. To obtain AoA it is necessary to use at least two antenna elements with overlapping lobes, and if a position in two planes is required it will be necessary with at least two antenna elements for elevation and two antenna elements for azimuth. Phase difference between received/read signals is detected and the phase difference can be the basis for calculation of AoA.

The present invention combines antenna design with means for either switching between antenna elements to obtain overlapping antenna lobes or obtaining overlapping antenna lobes by an antenna array with phase shifting

The RSSI-monopulse function method for AoA is based on an antenna with partly overlapping antenna lobes. For one plane two signals are formed, one being the sum of the two lobes, and the other being the difference of the two lobes. The ratio of these two lobes normalises the difference signal and allows the direction of arrival or AoA of the signal to be calculated. The shape of the antenna lobes must be known exactly to determine an accurate position determination. By doing this in two planes, elevation and azimuth, we obtain two values for AoA which gives a unique position in 2D. If a third plane different from the elevation and azimuth plane is known a full 3D position is obtained. The third plane may for instance be a horizontal plane such as ground or a floor etc.

The AoA is obtained by reading the RSSI-value from both lobes and calculating the difference-over-sum value with a unique value between −1 and +1 (the monopulse function), with a one-to-one relation to the AoA. The monopulse function curve is obtained by a measurement setup without multipath (in an anechoic camber, used for measuring antenna radiation patterns). RSSI values must be calibrated, calibration can be obtained by moving a tag, such as an RFID tag, an BT-tag or the like between predefined angles/positions over the antenna FOV in the two planes and the RSSI-value is recorded and associated with particular positions in the azimuth and elevation plane. These recordings are used to generate the monopulse function. The monopulse-function is generated from measurements in a controlled environment without multipath.

In one embodiment of the invention BLE-tags are tracked and located. The RSSI-level can be recorded from the three advertising channels of the BLE-tag, operating at different frequencies. The RSSI-level can be a single value or an average over many packets. To locate a BLE-tag, the antenna must be switched between the overlapping lobes, the recorded RSSI-values at the three advertising channels is saved and the monopulse value in elevation and in azimuth can be calculated when RSSI-values from the overlapping lobes are recorded.

In another embodiment of the invention passive RFID-tags are tracked and located. In an RFID system, readers send interrogation signals to the passive RFID-tags, which responds in turn via backscatter. The reader analyses the response and reports the RFID-tag's data along with the signal's RSSI. The reader is an antenna with associated circuitry for electronic signal processing. RSSI, is a measurement of the power received from the returned signal from an RFID-tag when interrogated by the reader. Based on read RSSI from overlapping lobes the monopulse value in elevation and in azimuth can be calculated.

RSSI in itself may not be a reliable measurement to use when calculating tag distance. Other RFID-tag data values such as the number of times a tag is read per second, and the amount of time it takes the tag to respond for the first time can be used in addition to RSSI when a position of an RFID-tag is calculated in elevation and azimuth.

For multiple RFID-tags, each RFID-tag covers one or multiple lobes. The RSSI value is saved from each RFID-tag, and the monopulse value in elevation and in azimuth can be calculated.

There can also be a combination of multiple RFID-tags and switching between lobes.

A general exemplification of the present invention will now be described with reference to the drawings.

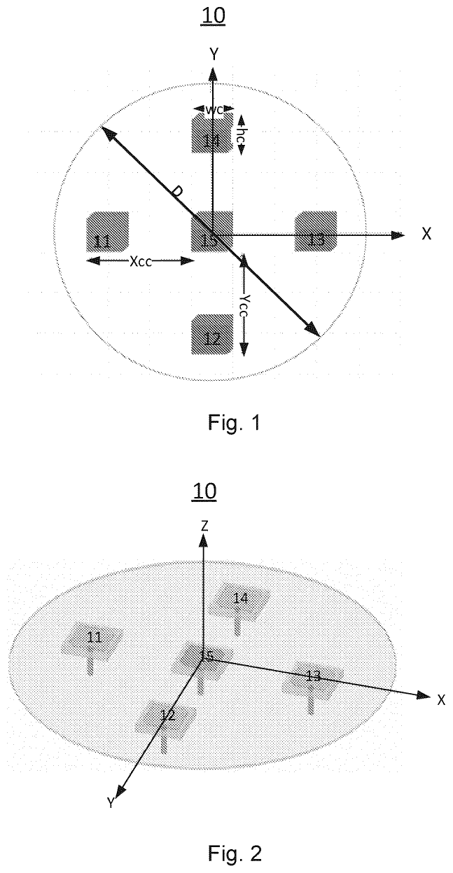

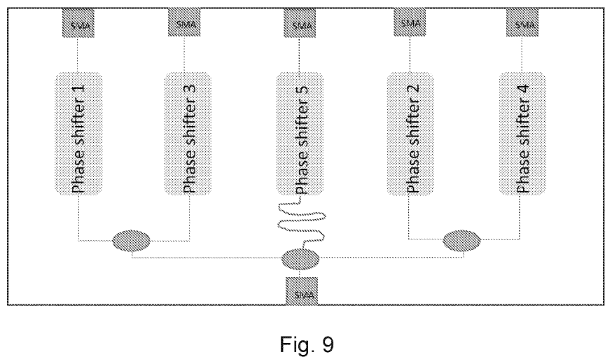

FIGS. 1 and 2 shows layout of a five-patch antenna, the five patch antennas are numbered 11-15 The antenna can also be realized with other antenna element types. The five-patch antenna is shaped as a planar disc. In the planar design of the five-patch antenna overlapping lobes are provided by controlling the phase shift to each of the five antenna elements, see also FIG. 9. Each lobe is obtained with predefined settings of all phase shifters, and by switching between the predefined phase settings switching between the lobes is possible. A boresight lobe can also be set up and be used for a first control of RSSI-value and also to send interrogation signals to passive RFID-tags.

It is possible to set up more than two overlapping lobes in each plane, elevation and azimuth, which can improve the accuracy of the AoA and hence the position.

A switched line phase shifter can be used for setting the phase shifts for the required antenna lobes. A switched line phase shifter will be fast enough to be combined with the AoA-method in BLE 5.1, if BLE-tags in compliance with Bluetooth Core Specification Version 5.1 is used. Additionally, the amplitude to the five patches can be predefined with a taper-function to obtain low sidelobe levels. This will avoid signals from entering through sidelobes and thereby reduce error effects from multipath.

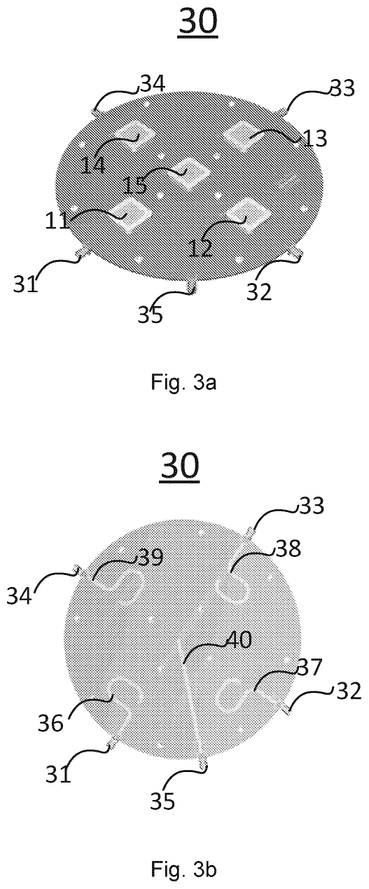

FIG. 3a shows the five-patch antenna from above with five coax connectors 31-35. The coax connectors can be connected with the controller/phase-shifter. FIG. 3b shows the backplane 30 of the five-patch antenna with each of the five coax connectors 31-35. FIG. 3b shows a conductive layer with an artwork pattern of conductors that provides electrical connections between the five coax connectors and each of the five patch antennas.

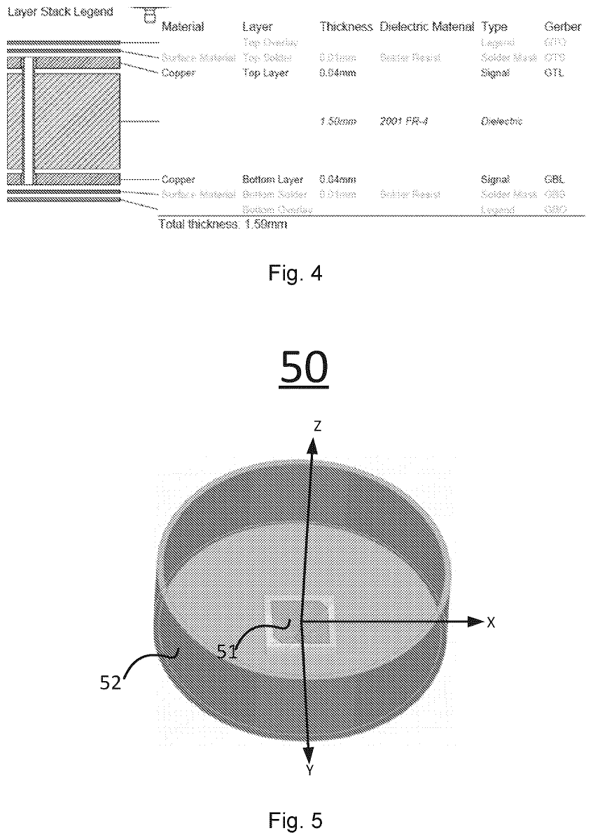

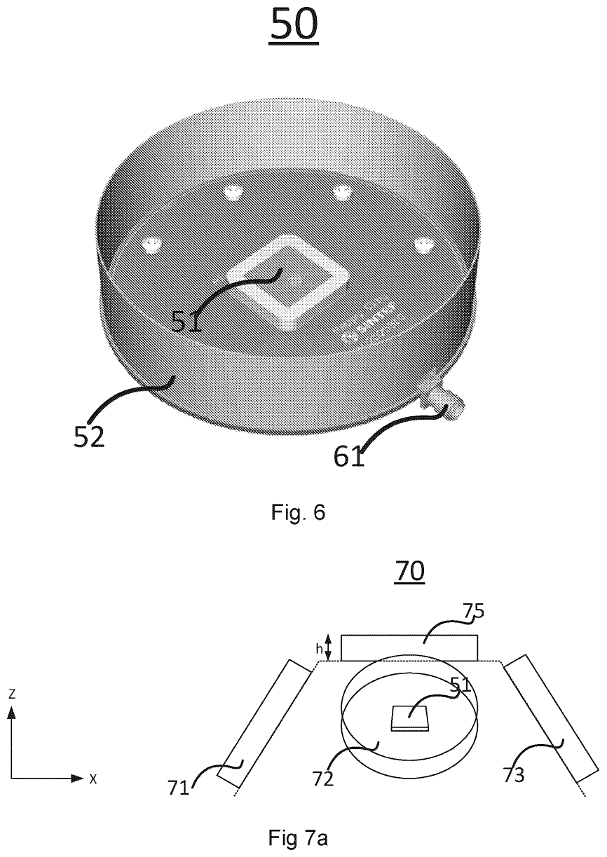

FIG. 4 shows the cross section of an example of the PCB used for the five-patch antenna.

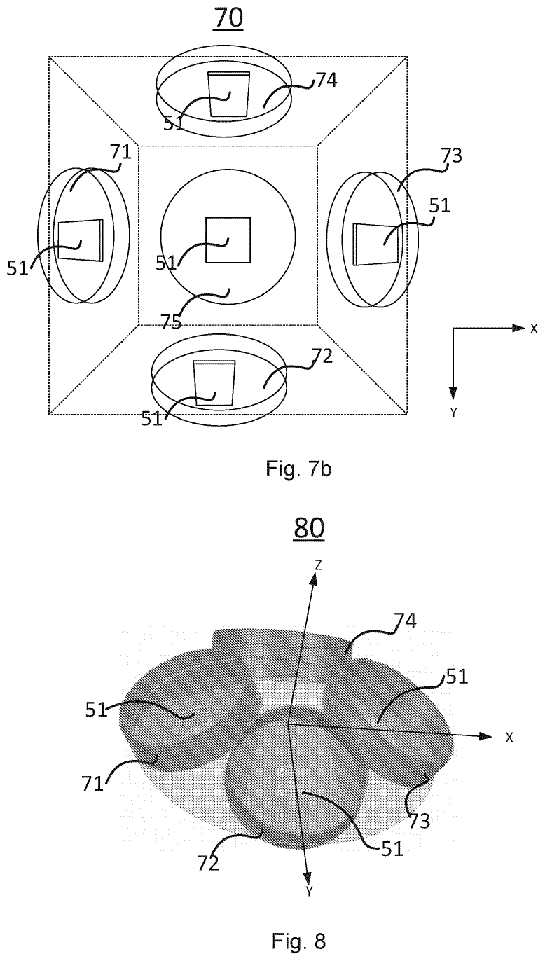

FIG. 5 shows a single patch antenna. In a second antenna design a 4×1-patch antenna is used, see FIG. 7a, 7b and FIG. 8. The 4×1 patch antenna includes four single element designs with an outer fence/sleeve. The antenna can also be realized with other antenna element types. The four patch antennas are tilted with their normal in the direction the lobe shall cover. Each lobe can be selected by switching between the four 1-patch elements for example with a SP4T (single pole 4 throw) component.

The second antenna design is less flexible than the planar five patch antenna 10, 30, but the FOV is larger. It also requires less components and the switch is a simpler and lower cost alternative than the controller/phase shifter of the planar five patch antenna.

A fifth single patch antenna can be added at the centre if a boresight lobe is required, which can be used for a first control of RSSI-value and also to send interrogation signals to passive RFID-tags. The antenna can also be realized with other antenna element types. A five single patch antenna will require an SP5T type switch.

Switching will be fast enough to be combined with the AoA-method in BLE 5.1

FIG. 7a, 7b and FIG. 8 shows the design of the second antenna the 4×1-patch antenna. It appears from the figures that each patch antenna 71-74 is tilted relative to a horizontal plane, this configuration will provide overlapping lobes without phase shifting between each of the four antenna elements. FIG. 7a and FIG. 7b differs from FIG. 8 in that a fifth patch antenna element 75 is included, the fifth patch antenna element 75 is not tilted relative to a horizontal plane (x,y).

The first five patch antenna and the second single patch antenna is shown in the figures as ceramic patch elements with circular polarization. But other antenna element designs can be used, with circular, linear, dual circular or dual linear polarization.

If BLE 5.1 tags shall be tracked one may provide overlapping lobes with frequency-scanned antenna types, where switching between lobes is not required as each of the three advertising channels will have different pointing lobes. The BLE 5.1 AoA method is based on switching between antenna elements and find the time delay (phase difference) of the signal from the same BLE 5.1 Tag, which can be equated back to AoA.

The two antenna designs above may both provide 2D position indication, to provide tracking of tagged objects several antennas of the design above will be necessary and if two or more antennas are used one will obtain 3D tracking of tagged objects as each antenna provides position parameters in two planes.

Reference table

| | |
|---|---|
| 10 | Planar five-patch antenna, including the five patch |
| | antennas 11. 12, 13, 14 and 15. The planar five |
| | patch antenna is seen from above parallel with the |
| | Z-axis. In another embodiment the planar antenna |
| | includes four patch antennas thereby providing |
| | a four-patch antenna, in yet another embodiment |
| | the planar antenna includes three patch antennas |
| | thereby providing a three-patch antenna. |
| 11-15 | Five patch antennas. |
| 30 | Planar five patch antenna in the form of a PCB, |
| | including antenna connectors 31-35. The planar |
| | five patch antenna is seen obliquely from above |
| | in FIG. 31 and parallel with negative Z-direction |
| | in FIG. 3b. In another embodiment the PCB |
| | includes four patch antennas thereby providing |
| | a four-patch antenna, in yet another embodiment |
| | PCB includes three patch antennas thereby |
| | providing a three-patch antenna. |
| 31-35 | Antenna connectors. Antenna connectors can be |
| | of the coax-type. |
| 36 | Printed circuit associated with antenna connector |
| | 31 |
| 37 | Printed circuit associated with antenna connector |
| | 32 |
| 38 | Printed circuit associated with antenna connector |
| | 33 |
| 39 | Printed circuit associated with antenna connector |
| | 34 |
| 40 | Printed circuit associated with antenna connector |
| | 35 |
| 50 | A board with one patch antenna - 1-patch PCB - |
| | with a surrounding fence/sleeve 52 standing |
| | vertically up from the perimeter of the PCB |
| | the PCB includes a single patch antenna 51. |
| 51 | Single patch antenna on a 1-patch PCB 50. |
| 52 | An outer fence/sleeve on a 1-patch PCB 50, |
| | the fence standing vertically up from the PCB of |
| | the 1-patch PCB 50. The fence/sleeve can have |
| | the effect of a wave guard. |
| 61 | An antenna connector connected with the patch |
| | antenna 51. |
| 70 | An antenna configuration including five x 1-patch |
| | PCB’s, four of them are shown the fifth 1-patch |
| | PCB is hidden behind the second 1-patch PCB in |
| | the Y-direction. In a second antenna design a four |
| | x 1-patch antenna is used, i.e., the fifth a-patch |
| | PCB is omitted, see FIG. 7a, 7b, and FIG. 8. The |
| | 4 x 1 patch antenna includes four single element |
| | designs with an outer fence/sleeve 52. In yet |
| | another antenna design three x 1-patch antennas |
| | are arranged tilted with respect to the XY-plane |
| | for example in the form of a triangular pyramid. |
| 71 | A first 1-patch PCB of the type shown in FIG. 5 |
| | with reference number 50. |
| 72 | A second 1-patch PCB of the type shown |
| | in FIG. 5 with reference number 50. |
| 73 | A third 1-patch PCB of the type shown |
| | in FIG. 5 with reference number 50. |
| 74 | A fourth 1-patch PCB of the type shown |
| | in FIG. 5 with reference number 50. |
| 75 | A fifth 1-patch PCB of the type shown |
| | in FIG. 5 with reference number 50. |
| 80 | An example of a four x 1-patch antenna design, |
| | including the four 1-patch antennas 71-74 each |
| | with a single patch antenna 51 |
| X | X depicts the X-direction in an orthogonal |
| | system, ref FIGS 1, 2, 5, 7a 7b and 8. |
| Y | Y depicts the Y-direction in an orthogonal |
| | system, ref FIGS 1, 2, 5, 7a 7b and 8. |
| Z | Z depicts the Z-direction in an orthogonal |
| | system, ref FIGS. 1, 2, 5, 7a 7b and 8. The Z |
| | direction is shown as a normal (vertical) to the |
| | XY-plane. |
| D | Diameter of the planar five patch antenna 10. |
| wc | Width of a patch antenna (11-15). The width |
| | is in the X-direction |
| hc | Depth of a patch antenna (11-15). The depth |
| | is in the Y-direction |
| X_{CC} | Distance between a first edge of a patch antenna |
| | and the same first edge of a neighbouring, in a |
| | x-direction, patch antenna. Ref. FIG. 1 |
| Y_{CC} | Distance between a first edge of a patch antenna |
| | and the same first edge of a neighbouring, in a |
| | Y-direction, patch antenna. Ref. FIG. 1 |
| h | Height of the fence/sleeve 52 from the PCB of |
| | the 1-Patch PCB 50 and to the upper edge of |
| | the fence/sleeve. |
| GPS | Global Positioning System |
| GNSS | Global Navigation Satellite Systems |
| RFID | Radio Frequency Identification |
| BLE | Bluetooth Low Energy |
| BLE 5.1 | Bluetooth Low Energy Bluetooth Core |
| | Specification Version 5.1 |
| RSSI | Received Signal Strength Indicator |
| AoA | Angle of Arrival |
| BT | Bluetooth |
| DoA | Direction of Arrival |
| FOV | Field of View |
| CTE | Constant Tone Extension |
| PCB | Printed circuit board |
| Tags | In the context of the present invention a tag can |
| | be a passive or active electronic chip, such |
| | as but not restricted to RFID-tags, BLE-chips, |
| | tags in the context of the present invention can |
| | communicate with the real-time location tracking |
| | antenna in accordance with the present |
| | invention . . . |
| 2D | Two dimensional |
| 3D | Three dimensional |
| SP4T | Is a four-way switch, single pole 4 throw, which |
| | is available for high frequencies (up to and above |
| | 44 GHz). |
| SP5T | Is a five-way switch, single pole 5 throw, |
| | which is available for high frequencies (up to |
| | and above 60 GHz). |

1. A real-time location tracking antenna configured to locate tags, the real-time location tracking antenna is a switched lobe antenna for 2D positioning which at least comprises:
a. at least three patch antenna elements (11, 12, 13, 14, 15, 70, 71, 72, 73, 74, 75) in an antenna;
b. means configured to set up at least three overlapping lobes in desired 2D FOV where each lobe overlaps with a neighbouring lobe, where the means is one of:
i. one first controller including one phase shifter module where the overlapping lobes are obtained by controlling the phase to each of the patch antenna elements (11-15, 70-75) utilising the phase shifter where the first controller at least further comprises:
recording means configured to:
read RSSI values from each of the at least three overlapping antenna lobes, and
the first controller is configured to record the read RSSI values, and
monopulse values in elevation and azimuth is calculated by the first controller based on RSSI values from overlapping lobes, thereby providing real-time 2D location tracking, and
ii. one second controller including one switching device and where the switching device is configured to switch between the at least three patch antenna elements (11-15, 70-75), where the second controller at least comprises:
recording means configured to:
read RSSI values from each of the at least three patch antenna elements (11-15, 70-75), and
the second controller is configured to record the read RSSI values, and
monopulse values in elevation and azimuth is calculated by the second controller based on RSSI values from overlapping lobes, thereby providing real-time 2D location tracking.

2. The real time tracking antenna in accordance with claim 1 wherein the recoding means at least comprises:
i. a microprocessor;
ii. memory modules, and
iii. at least three switches for connection between the microprocessor and each of the patch antenna elements.

3. The real time tracking antenna in accordance with claim 1 where the one phase shifter module includes at least three phase shifters where each of the at least three phase shifters are in functional communication with one patch antenna element (11-15, 70-75).

4. The real time tracking antenna in accordance with claim 1, where the real time tracking antenna comprises at least three equidistant arranged patch antenna elements (11-15, 70-75) on a single planar PCB.

5. The real time tracking antenna in accordance with claim 2 where the PCB including from the top: a top overlay, a top solder surface material, a copper top layer, a dielectric, copper bottom layer, a bottom solder surface and a bottom overlay, the PCB further includes five coax connectors for connection with the phase shifter module.

6. The real time tracking antenna in accordance with claim 1 wherein the one switching device includes at least three output ports, where each of the at least three output ports are connected with a patch antenna element (11-15, 70-75).

7. The real time tracking antenna in accordance with claim 1, where the real time tracking antenna either comprises at least three 1-patch antenna PCBs arranged tilted relative to an XY-plane, or
where the real time tracking antenna comprises at least three 1-patch antenna PCBs arranged tilted relative to an XY-plane and another patch antenna PCB arranged substantially parallel to an XY-plane.

8. The real time tracking antenna in accordance with claim 7, where the patch antenna PCB arranged substantially parallel to an XY-plane provides a boresight lobe and/or an RFID enabler.

9. The real time tracking antenna in accordance with claim 7, where the tilting angle of the three tilted 1-patch antenna PCBs are adjustable thereby enabling to tune field of view and lobe overlap between 1-patch antenna elements.

10. The real time tracking antenna in accordance with claim 7, where each of the tilted 1-patch antenna PCBs are tilted with the same absolute angle and each of the tilted 1-patch antenna PCBs are arranged in a right square frustum fashion, each of the tilted 1-patch antenna PCBs base being oriented parallel with separate side surfaces in the right square frustum fashion.

11. The real time tracking antenna in accordance with claim 7, where each of the tilted 1-patch antenna PCBs are tilted with the same absolute angle and each of the tilted 1-patch antenna PCBs are arranged in a triangular frustum fashion, each of the tilted 1-patch antenna PCBs base being oriented parallel with separate side surfaces in the triangular frustum fashion.

12. The real time tracking antenna in accordance with claim 7 where the overlapping lobe pattern is provided due to the relative geometric orientation between each of the tilted 1-patch antenna PCB boards.

13. The real time tracking antenna in accordance with claim 7 where each of the PCBs including from the top: a top overlay, a top solder surface material, a copper top layer, a dielectric, copper bottom layer, a bottom solder surface and a bottom overlay, each of the PCBs further includes one coax connector for connection with the switching module.

14. The real time tracking antenna in accordance with claim 7 where the 1-patch antenna PCBs are provided with a circular protruding edge along the perimeter of the circular PCB board, where the circular protruding edge is electrically connected to a ground plane of the 1-patch antenna PCB.

15. The real time tracking antenna in accordance with claim 7 where the fifth 1-patch antenna (75) PCB is arranged in a right square frustum fashion on a top surface of the right square frustum.

16. A real-time location tracking antenna system for 3D positioning which at least comprises two real-time location tracking antennas according to claim 1, where the two real time location tracking antennas are spatially separated and where a controller system reads 2D positioning values from the at least two real time location tracking antennas thereby providing a 3D positioning system.
